(19) United States
(12) Patent Application Publication
(10) Pub. No.: US 2024/0088752 A1
(43) Pub. Date: Mar. 14, 2024

(54) ROTATING ELECTRIC MACHINE

(71) Applicant: Mitsubishi Electric Corporation, Tokyo (JP)

(72) Inventors: Yusuke KIMOTO, Tokyo (JP); Tadashi MURAKAMI, Tokyo (JP); Junji KITAO, Tokyo (JP)

(73) Assignee: Mitsubishi Electric Corporation, Tokyo (JP)

(21) Appl. No.: 17/766,744

(22) PCT Filed: Jul. 31, 2020
(86) PCT No.: PCT/JP2020/029501

§ 371 Date: Apr. 6, 2022

(30) Foreign Application Priority Data
Nov. 20, 2019 (JP) 2019-209524

(51) Int. Cl. H02K 9/19; H02K 1/2706; H02K 7/116; H02K 9/22

(52) U.S. Cl. CPC H02K 9/19; H02K 1/2706; H02K 7/1163; H02K 9/227

(57) ABSTRACT

Provided is a rotating electric machine in which the coolant is efficiently circulated, thus having improved cooling performance. A rotating electric machine has a coolant pump-up mechanism provided with a motive-power transmission mechanism for transmitting rotational motive power of a rotor and an impeller which rotates via the motive-power transmission mechanism and efficiently pumps up a coolant. The motive-power transmission mechanism is provided at one end of a first shaft forming a rotation axis of the rotor and one end of a second shaft forming a rotation axis of the impeller and crossing the axial-length direction of the first shaft. In the coolant pump-up mechanism, a heat exchanger for cooling a coolant is provided at a lower part of the impeller, and through rotation of the rotor, the impeller supplies the coolant cooled by the heat exchanger to the first shaft side, thereby cooling a stator and the rotor.

### TECHNICAL FIELD

The present disclosure relates to a rotating electric machine including a coolant pump-up mechanism driven by rotation of a rotor.

### BACKGROUND ART

In a rotating electric machine, heat is generated due to rotor iron loss which increases in accordance with the vehicle speed and copper loss which occurs depending on current, and therefore the rotating electric machine is required to be efficiently cooled. In a conventional rotating electric machine, a coolant is supplied into the rotating electric machine by an electric pump provided outside the rotating electric machine, thereby cooling heat-generation parts. In the above rotating electric machine, power consumption by driving of the electric pump is great, and thus there is a problem that the entire rotating electric machine cannot be operated with high efficiency. In such a conventional rotating electric machine, in order to solve the above problem, a method of supplying a coolant using an oil pump driven by rotation of a rotor may be used (see, for example, Patent Document 1).

### CITATION LIST

### Patent Document

Patent Document 1: Japanese Laid-Open Patent Publication No. 2014-82841

### SUMMARY OF THE INVENTION

### Problems to be Solved by the Invention

However, with the oil pump described in Patent Document 1, it is difficult to pump up a coolant present under a stator, and the oil pump is placed at the same height as a lower part of the stator. In addition, also during operation, the coolant needs to be stored to a height of the stator. Therefore, the lower part of the stator is always immersed in the coolant, so that there is a problem that cooling is performed non-uniformly.

The present disclosure has been made to solve the above problem, and an object of the present disclosure is to provide a rotating electric machine configured so that a coolant present at a lower part can be easily pumped up, thus having improved cooling performance.

### Solution to the Problems

A rotating electric machine according to the present disclosure includes: a housing; a stator housed in the housing; a rotor which rotates on an inner side of the stator; a first shaft which extends in a rotation axis direction of the rotor so as to penetrate the rotor, and rotates together with the rotor; a second shaft extending in an up-down direction; a motive-power transmission mechanism which transmits rotational motive power of the first shaft to the second shaft; an impeller which is provided at a lower end of the second shaft and pumps up, to at least a height of the first shaft, a coolant present at a lower position than the first shaft in the housing, through rotation of the second shaft; and a passage for supplying the coolant pumped up to the height of the first shaft, to heat-generation parts of the rotor and the stator.

### Effect of the Invention

The present disclosure makes it possible to provide a rotating electric machine in which a coolant present at a lower part of a stator can be easily pumped up and thereby the coolant can be efficiently circulated, thus having improved cooling performance.

### BRIEF DESCRIPTION OF THE DRAWINGS

FIG. 1 is a sectional view showing a rotating electric machine according to embodiment 1.

FIG. 2 is a view of a rotor as seen from line A-A in FIG. 1.

FIG. 3 is an enlarged view of a part of the rotor shown in FIG. 2.

FIG. 4 is a non-output-side end plate as seen from line B-B in FIG. 1.

FIG. 5 is a schematic structure view of a heat exchanger according to embodiment 1.

FIG. 6 is an enlarged view of a part of the rotating electric machine shown in FIG. 1.

FIG. 7 is a sectional view showing a modification of the rotating electric machine according to embodiment 1.

FIG. 8 is a sectional view showing a rotating electric machine according to embodiment 2.

FIG. 9 shows projected sectional views of the inside of a casing projected at line C-C in FIG. 8.

FIG. 10 is a sectional view of a rotating electric machine according to embodiment 3, as seen in a rotation axis direction.

FIG. 11 is a sectional view of a rotating electric machine according to embodiment 3, as seen in a rotation axis direction.

FIG. 12 is a sectional view showing a rotating electric machine according to embodiment 4.

FIG. 13 is a schematic view showing an impeller according to embodiment 4.

FIG. 14 is a sectional view of the impeller shown in FIG. 13.

### DESCRIPTION OF EMBODIMENTS

### Embodiment 1

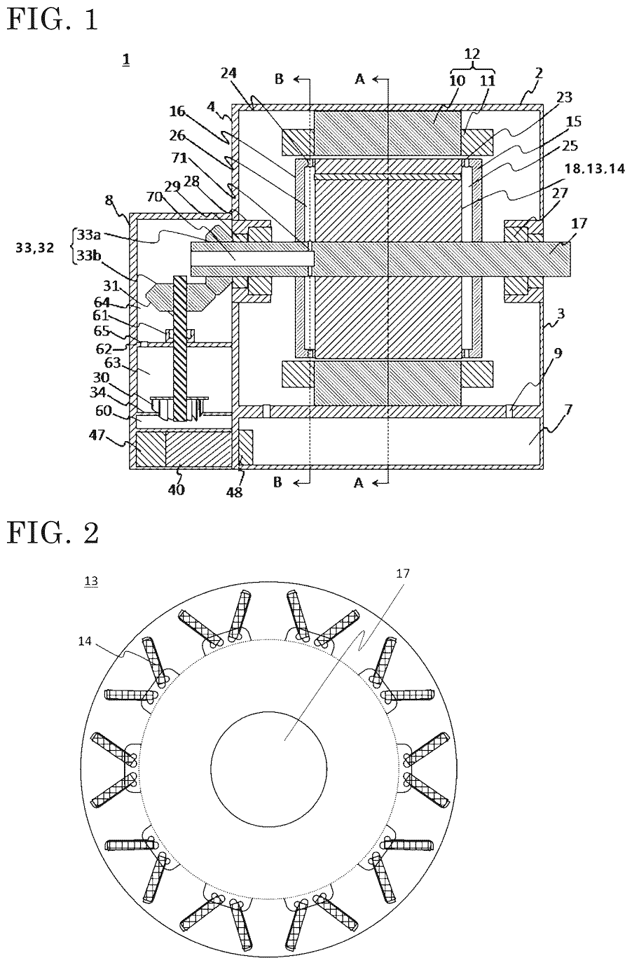

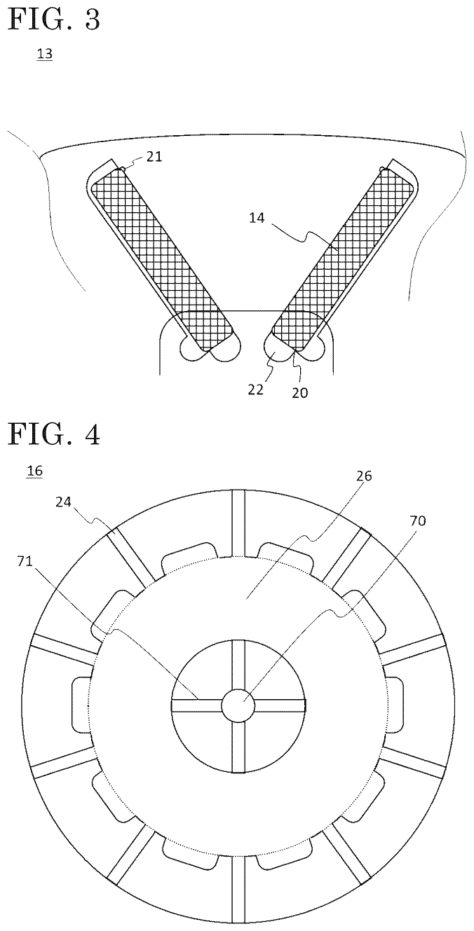

FIG. 1 is a sectional view of a rotating electric machine 1 according to embodiment 1 of the present disclosure. FIG. 2 is a sectional view of the rotating electric machine 1 along line A-A in FIG. 1, as seen in a rotation axis direction of a rotor. FIG. 3 is an enlarged view of a part of FIG. 2. FIG. 4 is a sectional view of the rotating electric machine 1 along line B-B in FIG. 1, as seen in the rotation axis direction of the rotor. Hereinafter, with reference to FIG. 1 to FIG. 4, the configuration of the rotating electric machine according to embodiment 1 will be described.

A basic configuration of the rotating electric machine 1 according to embodiment 1 will be described with reference to FIG. 1. The rotating electric machine 1 includes a housing 2 forming an outer frame, a cylindrical stator 12 provided in the housing 2, and a cylindrical rotor 18 provided on the radially inner side of the stator 12. At a center part of the rotor 18, a first shaft 17 forming a rotation axis of the rotor 18 is provided. The housing 2 has, at the bottom thereof, a drain portion 7 for storing a coolant for cooling. As used herein, a coolant 5 refers to a coolant that circulates inside the rotating electric machine 1.

The housing 2 which houses the stator 12 and the rotor 18 has a cylindrical shape and is formed by combining a disk-shaped output-side bracket 3 and a disk-shaped non-output-side bracket 4 on both sides. The housing 2 is made of metal, but may be made of resin. In a case of using metal, the weight of the rotating machine increases, but the material strength and the heat resistance are enhanced. On the other hand, in a case of using resin, the strength is lower than in the case of metal, but the corrosion resistance is higher and in addition, the weight of the rotating machine can be reduced and efficiency of an apparatus to which the rotating machine is mounted can be improved.

The stator 12 which is held by the housing 2 by shrink fit or bolts is composed of a stator core 10 (iron core) and a coil 11 (winding) mounted to the stator core 10.

The stator core 10 is formed by stacking thin steel sheets having excellent magnetic property, in the axial-length direction of the first shaft 17. The stator core 10 has tooth portions (not shown) protruding radially inward and arranged at predetermined intervals in the circumferential direction. Thus, when the stator core 10 is viewed in the axial-length direction of the first shaft 17, the tooth portions having n shapes are arranged in the circumferential direction. The tooth portions may be formed in T shapes, instead of n shapes. The coil 11 is formed by winding a conductive wire around each tooth portion, i.e., a part corresponding to a foot of the r shape of the stator core 10, using a radial direction of the first shaft 17 as an axis. The wound conductive wire is made of copper having high electric conductivity. The sectional shape of the conductive wire is a round shape, but may be a rectangular shape. Here, the “axial-length direction” refers to a direction in which the rotation axis extends.

The rotor 18 provided on the radially inner side of the stator 12 has a rotor core 13 and permanent magnets 14 embedded in the rotor core 13, and is fixed by being held between an output-side end plate 15 and a non-output-side end plate 16 at both ends.

The rotor core 13 has a cylindrical shape and is formed by stacking thin steel sheets having excellent magnetic property, i.e., high permeability and small iron loss, in the axial-length direction of the first shaft 17. The output-side end plate 15 and the non-output-side end plate 16 are made of metal, but may be made of resin. In a case of using metal, the weight of the rotating machine increases, but the material strength and the heat resistance are enhanced. On the other hand, in a case where the output-side end plate 15 and the non-output-side end plate 16 are made of resin, the strength is lower than in the case of metal, but the corrosion resistance is higher and in addition, the weight of the rotating machine can be reduced.

FIG. 2 is a sectional view of the rotor core 13 as seen from line A-A in the rotating electric machine 1 in FIG. 1. Inside the rotor core 13, two permanent magnets 14 adjacent to each other are arranged in a V shape so as to open radially outward of the first shaft 17. The shape of the permanent magnet 14 is a rectangular parallelepiped shape and is made of a material such as alnico, ferrite, or neodymium. FIG. 3 is an enlarged view of a part of the sectional view of the rotor core 13 in FIG. 2. The rotor core 13 has magnet insertion holes 20 into which the permanent magnets 14 are inserted, stress relaxing holes 21 for preventing the rotor core 13 from being damaged due to an action of a centrifugal force caused by rotation of the rotor 18, and magnet cooling holes 22 for cooling the permanent magnets 14. The magnet insertion holes 20 and the magnet cooling holes 22 are holes penetrating along the axial-length direction of the first shaft 17.

At a center part of the rotor 18, the first shaft 17 forming the rotation axis of the rotor 18 is provided and fixed to the rotor 18. The first shaft 17 is rotatably supported by an output-side bearing mechanism 27 at the output-side bracket 3, and is rotatably supported by a non-output-side bearing mechanism 28 at the non-output-side bracket 4. The output-side bearing mechanism 27 and the non-output-side bearing mechanism 28 are made of metal and the cross-sections thereof as seen in the rotation axis direction have doughnut shapes. The output-side bearing mechanism 27 and the non-output-side bearing mechanism 28 allow the rotor 18 including the first shaft 17 to rotate accurately and smoothly. Oil seals 29 are provided on the outer side of the output-side bearing mechanism 27 and the outer side of the non-output-side bearing mechanism 28.

Next, the structure of a part where the coolant flows inside the housing will be described.

FIG. 4 is a sectional view of the non-output-side end plate 16 as seen from line B-B in the rotating electric machine 1 in FIG. 1. The output-side end plate 15 and the non-output-side end plate 16 have disk shapes and respectively have, at radial-direction side surface parts, a plurality of output-side ejection holes 23 and a plurality of non-output-side ejection holes 24 directed toward the stator core 10 and the coil 11 of the stator 12. An output-side end plate coolant passage 25 serving as a passage for the coolant is formed between the output-side end plate 15 and the rotor core 13. Similarly, on the non-output side, a non-output-side end plate coolant passage 26 serving as a passage for the coolant is formed between the non-output-side end plate 16 and the rotor core 13. The non-output-side end plate coolant passage 26 and the output-side end plate coolant passage 25 communicate with each other via the magnet cooling holes 22 of the rotor core 13.

As shown in FIG. 1, in the first shaft 17, passages are provided for supplying the coolant 5 pumped up by an impeller 30 described later to heat-generation parts inside the housing 2. Inside the housing 2, the stator 12 and the rotor 18 generate heat. Therefore, the coolant 5 is supplied to the heat-generation parts through the passages provided in the first shaft 17, to cool the heat-generation parts.

The passages provided in the first shaft 17 are composed of an axial-direction passage 70 provided along the axial-length direction of the first shaft 17 and radial-direction passages 71 provided along the radial direction of the first shaft 17. The axial-direction passage 70 is provided along the axial-length direction, i.e., the rotation axis direction, of the first shaft 17, so that the coolant 5 flows from the non-output-side end to an intermediate part of the first shaft 17. The axial-direction passage 70 is formed as a hole having a circular cross-section as seen in the rotation axis direction. The radial-direction passages 71 are passages connecting the axial-direction passage 70 and the non-output-side end plate coolant passage 26, and extend radially from the center of the first shaft 17 toward the outer surface of the cylinder. In FIG. 4, four radial-direction passages 71 are shown as an example. However, one or more radial-direction passages 71 may be provided.

In the rotating electric machine 1 configured as described above, the coolant 5 supplied to the axial-direction passage 70 of the first shaft 17 flows through the radial-direction passages 71 into the non-output-side end plate coolant passage 26, and then divides into the non-output-side ejection holes 24 and the magnet cooling holes 22. The coolant 5 flowing into the magnet cooling holes 22 flows along the axial-length direction of the first shaft 17, passes through the output-side end plate coolant passage 25, and then is ejected from the output-side ejection holes 23.

Next, the structure of a pump-up mechanism for the coolant 5, in which the coolant 5 stored in the drain portion 7 at a lower part of the housing 2 is cooled and supplied again to the heat-generation parts inside the housing 2 will be described.

As shown in FIG. 1, the first shaft 17 is provided so as to protrude from the output-side bracket 3 and the non-output-side bracket 4 outward of the housing 2. At the part protruding on the output-side bracket 3 side, output of the rotating electric machine 1 is taken out. On the other hand, at the part protruding on the non-output-side bracket 4 side, the pump-up mechanism for the coolant 5 is provided for cooling the coolant 5 heated by the housing 2 and supplying the coolant 5 again through the axial-direction passage 70 of the first shaft 17 to the heat-generation parts inside the housing 2. The pump-up mechanism for the coolant 5 is housed in a casing 8 provided at an outer side surface of the housing 2. The casing 8 will be described later.

The pump-up mechanism for the coolant 5 is composed of a motive-power transmission mechanism 32 for transmitting rotational motive power of the rotor 18 to a second shaft 31, the impeller 30 for sucking the coolant 5, the second shaft 31 forming a rotation axis of the impeller 30, and the casing 8 which houses these components. The pump-up mechanism for the coolant 5 draws the coolant 5 from the drain portion 7 into a heat exchanger 40 provided in the casing 8, cools the coolant 5, and supplies the cooled coolant 5 again through the passages in the first shaft 17 to the heat-generation parts inside the housing 2. In the present disclosure, the pump-up mechanism for the coolant 5 has the impeller 30 to pump up the coolant 5 stored in the drain portion 7 at the lower part of the housing 2, to at least the height of the first shaft 17, and circulate the coolant 5 inside the rotating electric machine 1.

Next, a structure relevant to driving of the impeller 30 will be described.

The impeller 30 is attached to the second shaft 31 provided so as to extend in the up-down direction relative to the first shaft 17. The second shaft 31 is rotated by the motive-power transmission mechanism 32 transmitting rotational motive power of the first shaft 17. That is, the impeller 30 provided to the second shaft 31 is driven by rotation of the first shaft 17 via the motive-power transmission mechanism 32.

The motive-power transmission mechanism 32 for transmitting rotational motive power of the first shaft 17 to the second shaft 31 is provided between a part of the first shaft 17 protruding from the housing 2 on the non-output side of the housing 2, and one of both ends of the second shaft 31 that is near the non-output-side protruding part of the first shaft 17. The motive-power transmission mechanism 32 may be any mechanism that rotates the second shaft 31 by rotation of the first shaft 17, and may be formed by a gear, a bevel gear, a face gear, or the like. However, without limitation thereto, any other mechanism for transmitting rotational motive power of the first shaft 17 to the impeller 30 may be used. The motive-power transmission mechanism 32 may be made of metal or another material.

A case where the motive-power transmission mechanism 32 is formed by bevel gears 33 as an example will be described. A first gear 33a is provided at the part of the first shaft 17 protruding from the housing 2, and a second gear 33b is provided so as to mesh with the first gear 33a. The second gear 33b is fixed at one end of the second shaft 31. The first gear 33a and the second gear 33b each have a hole at the center, and the first shaft 17 and the second shaft 31 are respectively inserted and fixed in the holes.

The second shaft 31 is provided so as to extend in the up-down direction relative to the first shaft 17. In other words, the second shaft 31 is provided such that the rotation axis thereof is in a direction crossing the axial-length direction of the first shaft 17. That is, the first shaft 17 and the second shaft 31 are in such a relationship that their respective rotation axes cross each other when extended. FIG. 1 shows a case where the first shaft 17 and the second shaft 31 are perpendicular to each other, as an example of such a crossing relationship. The second shaft 31 may be provided in such a direction that ensures the relationship in which the first shaft 17 and the second shaft 31 cross each other when extended. Therefore, the second shaft 31 may be provided at such a position that the angle between the first shaft 17 and the second shaft 31 is not 90° (perpendicular) but 70° to 110°, for example. Thus, in the case where the first shaft 17 and the second shaft 31 are arranged in such a relationship that they cross each other when extended, a suction port of the impeller 30 described later contacts with the liquid surface of the coolant 5, in a parallel or inclined state. Therefore, the coolant 5 can be pumped up more efficiently and more assuredly than in a case where the first shaft 17 and the second shaft 31 are in such a positional relationship that they do not cross each other.

The impeller 30 for pumping up the coolant 5 is provided at a lower end of the second shaft 31, i.e., on a side of the second shaft 31 where the motive-power transmission mechanism 32 is not provided. The impeller 30 is formed by a disk and a plurality of vanes provided at a lower surface of the disk, and has a rotation axis at the center. The vanes are provided so as to extend radially outward from around the center, and have certain heights in the rotation axis direction of the second shaft 31, thus forming surfaces for whirling and raising the coolant 5 during rotation. Since the impeller 30 is attached to the second shaft 31, the second shaft 31 forms the rotation axis of the impeller 30. That is, the impeller 30 is provided such that the rotation axis of the impeller 30 is in a direction crossing the rotation axis of the first shaft 17. Further, the coolant pump-up mechanism has an impeller cover 34 provided so as to extend from the inner side surface of the casing 8 toward the impeller 30. The impeller cover 34 is provided such that an upper end of the impeller cover 34 is located lower than the disk of the impeller 30. The impeller cover 34 serves as a coolant suction port for the impeller 30. By providing the impeller 30 and the impeller cover 34 in such directions, the coolant 5 can be sucked in the rotation axis (second shaft 31) direction of the impeller 30 and can be caused to flow radially outward of the vanes of the impeller 30.

Thus, by providing the impeller 30 as in the pump-up mechanism for the coolant 5 in the present disclosure, it becomes possible to pump up the coolant 5 to the upper side of the impeller 30 more easily than in the case of a conventional pump. That is, the pump-up mechanism for the coolant 5 in the present disclosure can supply the coolant 5 stored in the drain portion 7 at the lower part of the housing 2 to the heat-generation parts inside the housing 2.

The casing 8 provided at the outer side surface of the housing 2 houses the non-output-side protruding part of the first shaft 17, the motive-power transmission mechanism 32, the second shaft 31, the impeller 30, and the impeller cover 34. The casing 8 is provided so as to be connected to the non-output-side bracket 4. Further, the heat exchanger 40 for exchanging heat with the coolant 5, and a first coolant storage portion 60 for storing the coolant 5 having undergone heat exchange, are provided inside the casing 8. That is, the pump-up mechanism for the coolant 5 is provided in the casing 8.

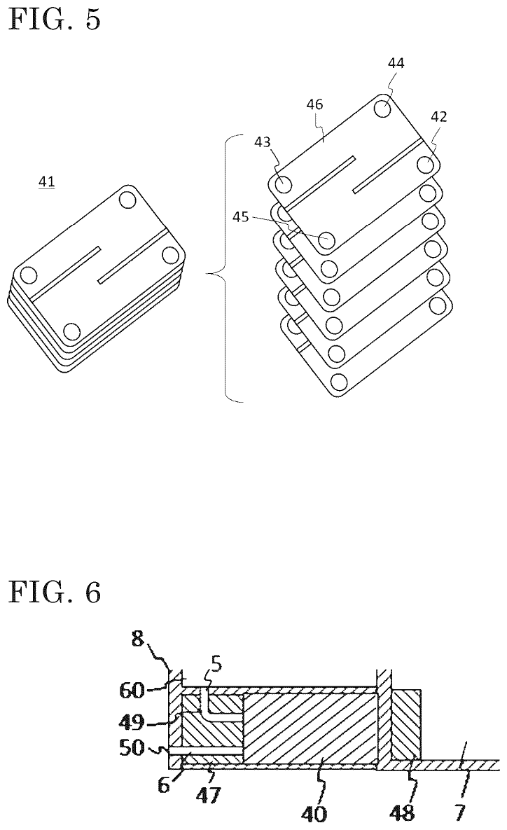

The heat exchanger 40 is provided at the bottom of the casing 8, and cools the coolant 5 stored in the drain portion 7 of the housing 2. That is, the heat exchanger 40 is provided at a position in contact with a side surface of the housing 2 at the bottom of the casing 8. Hereinafter, a structure relevant to the heat exchanger 40 will be described with reference to FIG. 5 and FIG. 6. FIG. 5 is a schematic structure view of a plate-type heat exchanger 41 which is an example of the heat exchanger 40. FIG. 6 is an enlarged sectional view of a major part around the heat exchanger 40, and shows the relationships between the heat exchanger 40 and the drain portion 7 and between the heat exchanger 40 and the first coolant storage portion 60.

The heat exchanger 40 is provided between the drain portion 7 and the first coolant storage portion 60 serving as a rotation space for the impeller 30. That is, the heat exchanger 40 is provided between the impeller 30 and the drain portion 7. In the conventional rotating electric machine, a structure acting as resistance, such as the heat exchanger 40 and a valve, is placed between a pump for sucking the coolant 5, e.g., a positive displacement pump such as a trochoid pump or a vane pump, and a coolant storage portion for storing the coolant 5, thus causing a problem of reducing the pump-up efficiency of the pump. However, in the present disclosure, by applying the impeller 30 instead of the conventional pump for sucking the coolant 5, it becomes possible to suck the coolant 5 with high efficiency through rotation of the impeller 30 even in the structure in which the heat exchanger 40 is provided between the impeller 30 and the drain portion 7.

Here, a coolant for exchanging heat with the coolant 5 via the heat exchanger 40 is referred to as an external coolant 6. As described above, the coolant 5 is a coolant 5 that circulates inside the rotating electric machine 1, and cools the stator core 10, the coil 11, and the permanent magnets 14. On the other hand, the external coolant 6 is a coolant taken into the heat exchanger 40 from the outside of the casing 8 so as to exchange heat with the coolant 5. As the coolant 5 and the external coolant 6, oil, a long life coolant (LLC), or the like is used. Although they are discriminated from each other for convenience of description, the coolant 5 and the external coolant 6 may be the same kind of coolant.

The plate-type heat exchanger 41 shown in FIG. 5 is formed by stacking heat transfer plates 46 having coolant flow-in/out holes 42, 43 through which the coolant 5 flows in and out and external coolant flow-in/out holes 44, 45 through which the external coolant 6 flows in and out. In the heat transfer plate 46, a pair of the coolant flow-in/out holes 42, 43 and a pair of the external coolant flow-in/out holes 44, 45 are each located at diagonal positions with respect to the center of the heat transfer plate 46. The heat transfer plates 46 are stacked such that the heat transfer plates 46 through which only the coolant 5 flows and the heat transfer plates 46 through which only the external coolant 6 flows overlap each other alternately, so that the respective coolants are not mixed with each other. The plate-type heat exchanger 41 is relatively high in heat exchange efficiency per unit volume as compared to other heat exchangers. Therefore, by using the plate-type heat exchanger 41 as the heat exchanger 40 in the present disclosure, a place needed for providing the heat exchanger inside the rotating electric machine 1 is reduced, whereby the entire rotating electric machine 1 can be downsized.

As shown in FIG. 6, a second flow-in/out direction switching mechanism 48 is provided between the drain portion 7 and the heat exchanger 40, and a first flow-in/out direction switching mechanism 47 is provided between the heat exchanger 40 and the first coolant storage portion 60. That is, in FIG. 6, the first flow-in/out direction switching mechanism 47 is located on a lower side in the gravity direction of the impeller 30.

The first flow-in/out direction switching mechanism 47 is provided with a coolant passage 49 for connecting the first coolant storage portion 60 and the coolant flow-in/out holes 42, 43 of the plate-type heat exchanger 41, and an external coolant passage 50 for connecting the outside of the casing 8 and the external coolant flow-in/out holes 44, 45 of the plate-type heat exchanger 41. The second flow-in/out direction switching mechanism 48 is provided with a coolant passage 49 for connecting the drain portion 7 and the coolant flow-in/out holes 42, 43 of the plate-type heat exchanger 41, and an external coolant passage 50 for connecting the outside of the housing 2 and the external coolant flow-in/out holes 44, 45 of the plate-type heat exchanger 41.

FIG. 6 shows an example of connections between parts in a case where the coolant passage 49 of the first flow-in/out direction switching mechanism 47 is connected to the coolant flow-in/out hole 43 of the plate-type heat exchanger 41. In this case, the second flow-in/out direction switching mechanism 48 switches passage connections so that the coolant passage 49 of the second flow-in/out direction switching mechanism 48 is connected to the coolant flow-in/out hole 42 of the plate-type heat exchanger 41 and the external coolant passage 50 of the second flow-in/out direction switching mechanism 48 is connected to the external coolant flow-in/out hole 44 of the plate-type heat exchanger 41.

Since the first flow-in/out direction switching mechanism 47 and the second flow-in/out direction switching mechanism 48 are provided as described above, it becomes possible to cause the external coolant 6 to flow to the outside of the rotating electric machine 1 without being mixed with the coolant 5.

The first coolant storage portion 60 is provided at such a position that the coolant 5 having undergone heat exchange in the heat exchanger 40 is stored thereto via the first flow-in/out direction switching mechanism 47, and serves as a rotation space for the impeller 30. As seen from the bottom side of the rotating electric machine 1, the height of the liquid surface of the coolant 5 in the first coolant storage portion 60 is desirably such a height that the impeller 30 is immersed in the coolant 5 before pumping up of the coolant is started, and the liquid surface becomes higher than the impeller 30 when the coolant 5 is started to be pumped up.

As shown in FIG. 1, in the casing 8, an impeller bearing mechanism 61 for supporting the second shaft 31 is provided via a support member 62. On the lower side of the support member 62, i.e., on the side where the impeller 30 is provided, a second coolant storage portion 63 for storing the coolant 5 pumped up from the first coolant storage portion 60 by the impeller 30 is provided. On the upper side of the support member 62, i.e., on the side where the motive-power transmission mechanism 32 is provided, a third coolant storage portion 64 for storing the coolant 5 that has flowed in from the second coolant storage portion 63 is provided. The support member 62 has a communication hole 65 through which the second coolant storage portion 63 and the third coolant storage portion 64 communicate with each other.

The coolant 5 naturally serves as a lubricant for the entire rotating electric machine 1, and further, since the coolant 5 is also stored at a part where the motive-power transmission mechanism 32 is provided in the third coolant storage portion 64, the coolant 5 also serves as a lubricant for the motive-power transmission mechanism 32. Since the coolant 5 serves as a lubricant for the motive-power transmission mechanism 32, it is possible to transmit motive power more efficiently.

Next, with reference to FIG. 1 to FIG. 6, a coolant circulation flow in the rotating electric machine 1 and operation of the pump-up mechanism for the coolant 5, according to embodiment 1, will be described.

When the rotor 18 starts to rotate, the motive-power transmission mechanism 32 transmits motive power to the second shaft 31 in conjunction with rotation of the first shaft 17. The second shaft 31 receiving motive power from the motive-power transmission mechanism 32 rotates together with the impeller 30 provided to the second shaft 31. That is, the first gear 33a fixed to the first shaft 17 rotates along with rotation of the first shaft 17, thus rotating the second gear 33b meshed with the first gear 33a via grooves. Since the second gear 33b is fixed to the second shaft 31, the second shaft 31 also rotates along with rotation of the second gear 33b, so that the impeller 30 provided at the lower end of the second shaft 31 also rotates.

Since the impeller 30 is immersed in the coolant 5 in the first coolant storage portion 60, the impeller 30 starts to pump up (suck and eject (push up the liquid surface)) the coolant 5 from the drain portion 7 through rotational operation of the impeller 30. That is, when the impeller 30 is rotated by rotation of the first shaft 17, the coolant 5 around the impeller 30, stored in the first coolant storage portion 60, is whirled, and then the coolant 5 is sucked to the inside of the impeller 30 from the coolant suction port provided to the impeller cover. Here, since the coolant suction port for the impeller 30 is made narrower than the width of the second coolant storage portion 63 by the impeller cover, the coolant 5 is sucked to the inside of the impeller 30. The coolant 5 sucked to the inside of the impeller 30 is whirled by rotation of the impeller 30, so as to be subjected to a centrifugal force, and thus flows radially outward of the impeller 30. The coolant 5 flowing out from the impeller 30 moves along the side wall of the second coolant storage portion 63, to rise toward the third coolant storage portion 64. That is, through rotation of the impeller 30, the coolant 5 stored in the drain portion 7 flows radially outward of the vanes of the impeller 30, and the coolant 5 flowing out moves along the inner walls of the second coolant storage portion 63 and the third coolant storage portion 64, to rise to the upper part of the impeller 30. In this way, through rotational operation of the impeller 30, a pump-up effect of raising the coolant 5 to at least the height of the first shaft 17 in the casing 8 is obtained.

The coolant 5 raised in the casing 8 by the pump-up effect provided through rotational operation of the impeller 30 passes through the second coolant storage portion 63 and the communication hole 65, to be led to the third coolant storage portion 64.

The coolant 5 led to the third coolant storage portion 64 flows into the axial-direction passage 70 provided in the first shaft 17, and leads to the radial-direction passages 71. Since the radial-direction passages 71 extend in the radial direction of the first shaft 17, the coolant 5 leading to the radial-direction passages 71 in the first shaft 17 is subjected to an action of a centrifugal force when the rotor 18 starts to rotate. By the centrifugal force, the coolant 5 can be led to the radial-direction passages 71 from the axial-direction passage 70 on the downstream side. The action of the centrifugal force caused in the radial-direction passages 71 has a characteristic of increasing in proportion to the rotational speed of the rotor 18.

By the centrifugal force of the rotor 18, the coolant 5 led from the axial-direction passage 70 of the first shaft 17 to the radial-direction passages 71 of the first shaft 17 flows into the non-output-side end plate coolant passage 26 formed by the non-output-side end plate 16 and the rotor core 13. The coolant 5 having flowed into the non-output-side end plate coolant passage 26 is subjected to the centrifugal force by rotation of the rotating electric machine 1, thus dividing into the non-output-side ejection holes 24 radially formed in the non-output-side end plate 16 and the magnet cooling holes 22 provided in the rotor core 13.

The coolant 5 ejected from the non-output-side ejection holes 24 is sprayed to the stator core 10 and the coil 11 located on the radially outer side of the non-output-side end plate 16. The ejected coolant 5 is directly supplied to the stator core 10 and the coil 11 which continuously generate heat, whereby cooling with high efficiency can be performed.

Meanwhile, the coolant 5 having flowed into the magnet cooling holes 22 moves to the output side of the rotating electric machine 1 in parallel to the first shaft 17 while directly cooling the permanent magnets 14 generating heat, so as to be led to the output-side end plate coolant passage 25 provided between the output-side end plate 15 and the rotor core 13. Also in the output-side end plate coolant passage 25, the coolant 5 is continuously subjected to the centrifugal force, and thus is ejected through the output-side ejection holes 23 provided in the output-side end plate 15. The ejected coolant 5 is sprayed to the stator core 10 and the coil 11 located on the radially outer side of the output-side end plate 15, thereby cooling the stator core 10 and the coil 11.

As described above, the coolant 5 is ejected from the output-side ejection holes 23 and the non-output-side ejection holes 24 provided at both ends in the axial direction of the rotating electric machine 1, whereby the stator core 10 and the coil 11 which generate heat can be cooled uniformly without unevenness in the rotation axis direction and also in the radial direction. Further, the above series of passages has many flow resistances such as many curves, narrowed parts, and enlarged parts. In the rotating electric machine 1, not only the pump-up effect caused by rotation of the impeller 30 but also a pump-up effect caused in the radial-direction passages 71 through rotation of the first shaft 17 is provided. Therefore, it is possible to supply the coolant 5 to predetermined passages even though there are many flow resistances in the rotating electric machine 1.

The coolant 5 ejected from the output-side ejection holes 23 and the non-output-side ejection holes 24 drop to the lower part of the housing 2 due to the action of gravity. The coolant 5 having dropped to the lower part of the housing 2 passes through a passage hole 9 leading to the drain portion 7 provided at the bottom of the housing 2, so as to be stored in the drain portion 7. That is, the coolant 5 having dropped due to the action of gravity returns to the drain portion 7 through the passage hole 9.

The coolant 5 returning to the drain portion 7 has received heat from the stator core 10, the coil 11, and the permanent magnets 14 and thus has an increased temperature. The coolant 5 having an increased temperature is drawn again into the heat exchanger 40 by the impeller 30 driven through rotation of the first shaft 17. The drawn coolant 5 exchanges heat with the external coolant 6 having a lower temperature than the coolant 5, in the heat exchanger 40. Since the external coolant 6 has a lower temperature than the coolant 5, the coolant 5 having an increased temperature is cooled.

Here, flow of the coolant 5 inside the plate-type heat exchanger 41 which is an example of the heat exchanger 40 will be described.

The coolant 5 having flowed into the second flow-in/out direction switching mechanism 48 from the drain portion 7 flows through the coolant flow-in/out holes 42 or the coolant flow-in/out holes 43 into the plate-type heat exchanger 41. The coolant 5 exchanges heat with the external coolant 6 inside the plate-type heat exchanger 41, and then is supplied to the first coolant storage portion 60 and the impeller 30 from the coolant passage 49 of the first flow-in/out direction switching mechanism 47. Meanwhile, the external coolant 6 flows in through the external coolant passage 50 in the first flow-in/out direction switching mechanism 47. The external coolant 6 passes through the external coolant flow-in/out holes 44 or the external coolant flow-in/out holes 45 of the plate-type heat exchanger 41, and exchanges heat with the coolant 5 inside the plate-type heat exchanger 41. Then, the external coolant 6 flows to the outside of the rotating electric machine 1 from the second flow-in/out direction switching mechanism 48. In the first flow-in/out direction switching mechanism 47 and the second flow-in/out direction switching mechanism 48, the coolant 5 flows through the coolant passage 49 and the external coolant 6 flows through the external coolant passage 50.

Then, the coolant 5 supplied to the first coolant storage portion 60 and the impeller 30 passes through the axial-direction passage 70 and the radial-direction passages 71 in the first shaft 17 again, and cools the stator core 10, the coil 11, and the permanent magnets 14 which are heat-generation parts. The coolant 5 circulating inside the rotating electric machine 1 through the above series of operations can be circulated by rotational motive power of the rotor 18 in the rotating electric machine 1.

As described above, the rotating electric machine 1 according to embodiment 1 has the coolant pump-up mechanism provided with the impeller 30 driven by rotational motive power of the rotor 18, whereby it becomes possible to easily draw the coolant 5 from the drain portion 7 into the heat exchanger 40, cool the coolant 5, and pump up the coolant 5 to the upper side of the impeller 30. The coolant 5 pumped up to the upper side of the impeller 30 is led to the stator 12 and the rotor 18 through the axial-direction passage 70 and the radial-direction passages 71 of the first shaft 17, whereby the stator 12 and the rotor 18 can be cooled. Since the coolant 5 can be efficiently pumped up and circulated, the heat-generation parts can be sufficiently cooled, and thus a rotating electric machine having improved cooling performance can be obtained.

In the pump-up mechanism for the coolant 5 in the present disclosure, the rotation axis (first shaft 17) of the rotor 18 and the rotation axis (second shaft 31) of the impeller 30 cross each other, and therefore the rotating electric machine 1 can be downsized. In addition, since all the coolant 5 circulating in the housing 2 undergoes heat exchange in the heat exchanger 40 and then is supplied to the heat-generation parts, cooling efficiency is improved as compared to a case where a part of the coolant 5 undergoes heat exchange and then is supplied to the heat-generation parts. Further, since the coolant 5 is led also to parts where the motive-power transmission mechanism 32 and the impeller 30 as the pump-up mechanism for the coolant 5 are provided, the coolant 5 also serves as a lubricant for the motive-power transmission mechanism 32 and the impeller 30, whereby the coolant 5 can be efficiently pumped up and circulated. Since the coolant 5 can be efficiently pumped up and circulated, the heat-generation parts can be sufficiently cooled, and thus a rotating electric machine having improved cooling performance can be obtained.

As described above, the rotating electric machine 1 according to the present disclosure has the pump-up mechanism for the coolant 5 provided with the impeller 30 driven by rotational motive power of the rotor 18, thereby providing an effect of obtaining the rotating electric machine 1 in which the coolant 5 present at the lower part of the stator 12 can be easily pumped up and the coolant 5 can be efficiently circulated, thus having improved cooling performance.

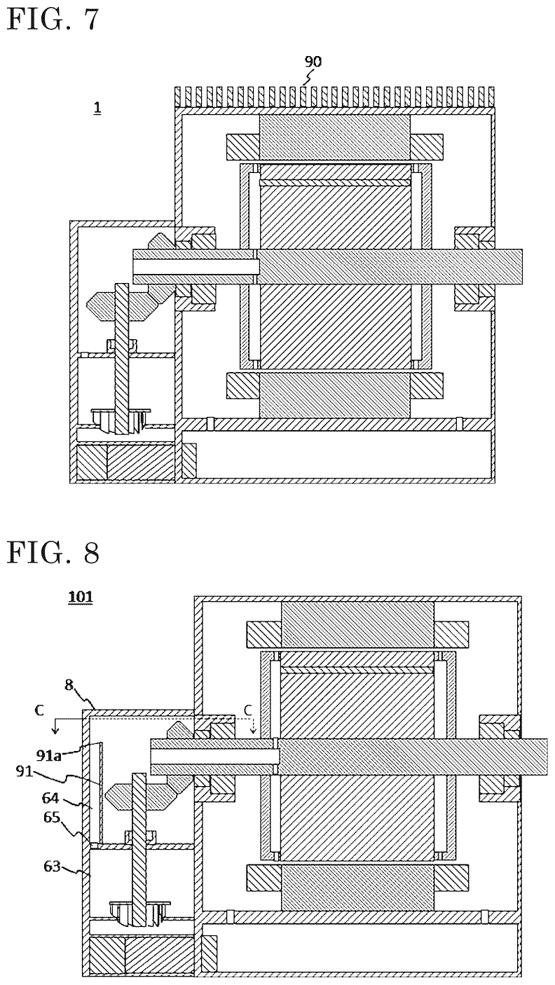

Next, a modification of embodiment 1 of the present disclosure will be described with reference to FIG. 7.

This modification is different in that heat dissipation fins 90 for dissipating heat is provided to the rotating electric machine 1 of embodiment 1. FIG. 7 is a sectional view of the rotating electric machine 1 according to this modification. The heat dissipation fins 90 are attached to an outer surface other than the bottom surface of the housing 2. The heat dissipation fins 90 dissipate heat by transferring heat generated in the rotating electric machine 1 to air outside the housing 2.

In the housing 2, the high-temperature coolant 5 heated as a result of cooling the stator core 10, the coil 11, and the permanent magnets 14 is stored in the drain portion 7. The side surfaces and the bottom of the drain portion 7 correspond to inner walls of the housing 2. Since the housing 2 is made of metal or resin, heat of the coolant 5 stored in the drain portion 7 can be transferred through the housing 2 to the heat dissipation fins 90. In addition, since the stator 12 is fixed to the housing 2, heat generated in the stator 12 can also be transferred through the housing 2 to the heat dissipation fins 90. The heat dissipation fins 90 are in contact with the outside air and therefore enable exchange of heat transferred from the housing 2 with the outside air.

As described above, heat generated in the housing 2 is transferred to the heat dissipation fins 90, whereby heat of the housing 2 can be efficiently dissipated to the outside of the housing 2. Thus, owing to air cooling using the heat dissipation fins 90, heat exchange in the heat exchanger 40 can be facilitated.

According to this modification, the effects in embodiment 1 are obtained, and in addition, the rotating electric machine 1 having more improved cooling performance can be obtained.

### Embodiment 2

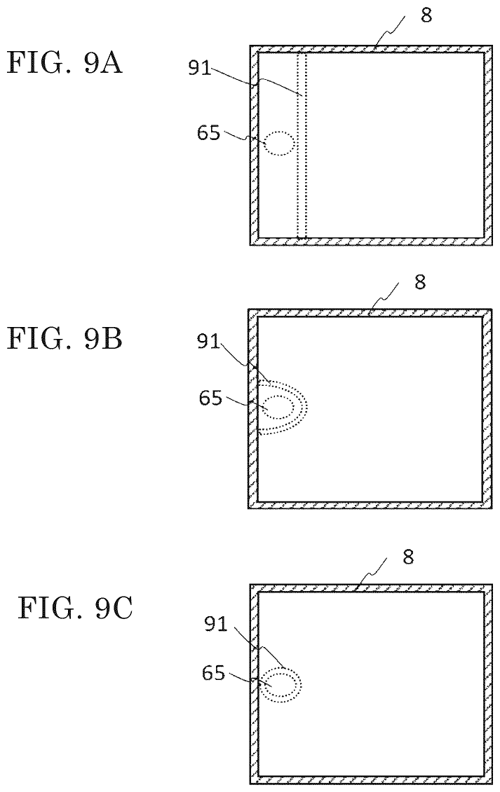

A rotating electric machine 101 according to embodiment 2 of the present disclosure will be described with reference to FIG. 8 and FIG. 9. In FIG. 8 and FIG. 9, the same reference characters as those in FIG. 1 denote the same or corresponding parts. In embodiment 2, a reverse-flow preventing member 91 for the coolant 5 is provided to the third coolant storage portion in the rotating electric machine 1 according to embodiment 1.

FIG. 8 is a sectional view of the rotating electric machine 101 according to embodiment 2 of the present disclosure. The pump-up mechanism for the coolant 5 in the rotating electric machine 101 is driven by rotation of the rotor 18. Therefore, when rotation of the rotor 18 is stopped, rotation of the impeller 30 is stopped, so that the coolant 5 stored in the third coolant storage portion 64 might reversely flow to the second coolant storage portion 63 due to the action of gravity. Considering this, in the rotating electric machine 101 according to embodiment 2, the reverse-flow preventing member 91 is provided in the third coolant storage portion 64 so as to prevent reverse flow of the coolant 5.

The reverse-flow preventing member 91 is formed such that a distal end 91a thereof is located higher than the height of the axial-direction passage 70 of the first shaft 17, in comparison with reference to the support member 62. However, the reverse-flow preventing member 91 is not a member that completely partitions the third coolant storage portion 64 into an area where the communication hole 65 is present and an area where the communication hole 65 is not present. The reverse-flow preventing member 91 is formed such that, at an upper part of the third coolant storage portion 64, the coolant 5 having flowed in from the communication hole 65 can pass beyond the distal end 91a of the reverse-flow preventing member 91 to flow into the area where the motive-power transmission mechanism 32 and one end of the first shaft 17 are present. FIG. 9(a) to FIG. 9(c) are projected sectional views in which the reverse-flow preventing member 91 and the communication hole 65 are projected when the inside of the casing 8 in FIG. 8 is viewed from line C-C. The shape of the reverse-flow preventing member 91 may be a plate shape, or a cylindrical or semi-cylindrical shape having a diameter equal to that of the communication hole 65 or a diameter larger than that of the communication hole 65. FIG. 9(a) is a sectional view in a case where the shape of the reverse-flow preventing member 91 is a plate shape, FIG. 9(b) is a sectional view in a case where the shape of the reverse-flow preventing member 91 is a semi-cylindrical shape, and FIG. 9(c) is a sectional view in a case where the shape of the reverse-flow preventing member 91 is a cylindrical shape having a diameter larger than that of the communication hole 65.

Also in the rotating electric machine 101 according to embodiment 2 configured as described above, the same operation as in the rotating electric machine 1 according to embodiment 1 is performed. Therefore, only operation relevant to the reverse-flow preventing member 91 will be described below. The coolant 5 passes through the communication hole 65 of the support member 62 from the second coolant storage portion 63, is raised to a height beyond the distal end 91a of the reverse-flow preventing member 91 in the third coolant storage portion 64, and then is stored in the third coolant storage portion 64. Therefore, even in a case where rotation of the rotor 18 is stopped and the coolant 5 attempts to reversely flow to the second coolant storage portion 63 due to gravity, the coolant 5 never reversely flows through the communication hole 65 to the second coolant storage portion 63 unless the coolant 5 moves beyond the height of the distal end 91a of the reverse-flow preventing member 91. That is, reverse flow of the coolant 5 can be prevented.

In the rotating electric machine 101 according to embodiment 2, since the reverse-flow preventing member 91 is provided in the third coolant storage portion 64, reverse flow of the coolant 5 can be prevented even when the rotor 18 is stopped. Since reverse flow of the coolant 5 can be prevented, the stator 12 and the rotor 18 can be appropriately cooled.

As described above, in the rotating electric machine 101 according to embodiment 2, the reverse-flow preventing member 91 is further provided to the rotating electric machine 1 of embodiment 1. Therefore, even when rotation of the rotor 18 is stopped, it is possible to inhibit the coolant 5 from reversely flowing from the third coolant storage portion 64, thereby obtaining the rotating electric machine 101 in which the heat-generation parts can be appropriately cooled, thus having improved cooling performance.

### Embodiment 3

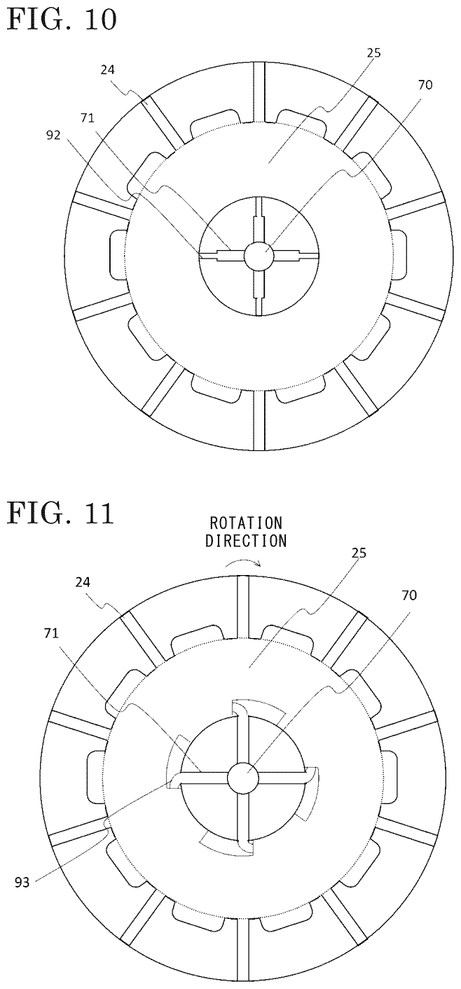

A rotating electric machine 201 according to embodiment 3 of the present disclosure will be described with reference to FIG. 10 and FIG. 11. In FIG. 10 and FIG. 11, the same reference characters as those in FIG. 1 denote the same or corresponding parts. In the rotating electric machine 201 according to embodiment 3, the shapes of the radial-direction passages 71 are changed as compared to the rotating electric machine 1 according to embodiment 1. Therefore, a sectional view (not shown) of the rotating electric machine 201 according to embodiment 3 is the same as the sectional view of the rotating electric machine 1 according to embodiment 1 shown in FIG. 1.

FIG. 10 and FIG. 11 are sectional views of the non-output-side end plate 16 as seen from line B-B in the rotating electric machine 1 shown in FIG. 1, and correspond to modifications of FIG. 4. The exit shape of each radial-direction passage 71 of the first shaft 17 in FIG. 4 may be formed to be a shape having a narrowed portion 92 as shown in FIG. 10 or a shape having a bent portion 93 as shown in FIG. 11.

The narrowed portion 92 in FIG. 10 is formed such that the radial-direction passage 71 has a shape in which the passage sectional area on the radially outer side is smaller than the passage sectional area on the radially inner side. The radially outer side of the radial-direction passage 71, i.e., the exit part of the radial-direction passage 71, is narrowed and thus functions as a great-pressure-loss part. In a case where the narrowed portion 92 is not present, when the rotational speed of the rotor 18 increases, air reversely flows from the non-output-side end plate coolant passage 26 formed by the rotor core 13 and the non-output-side end plate 16 and communicating with radial-direction passage 71, so that the pump-up effect might not be exerted. In contrast, if the radial-direction passage 71 has the narrowed portion 92 so that the part near the exit is narrowed, great pressure increase occurs and thus reverse flow of air from the radial-direction passage 71 can be inhibited.

The bent portion 93 in FIG. 11 is formed in such a shape that the exit part of the radial-direction passage 71 is bent in a direction opposite to the rotation direction of the rotor 18. The end of the radial-direction passage 71 is bent as described above and thus the bent part functions as a pressure loss part near the exit of the radial-direction passage 71, as in the narrowed portion 92 shown in FIG. 10. Thus, it is possible to continue pumping up the coolant 5 while inhibiting reverse flow of air from the non-output-side end plate coolant passage 26. Although the narrowed portion 92 and the bent portion 93 are described separately from each other, the exit shape of the radial-direction passage 71 may have a shape obtained by combining the narrowed portion 92 and the bent portion 93. It is possible to inhibit reverse flow of air from the radial-direction passage 71 even by such a shape obtained by combining the narrowed portion 92 and the bent portion 93.

In the rotating electric machine 201 according to embodiment 3, a structure for causing loss of pressure (narrowed portion 92, bent portion 93) is provided to the radial-direction passage 71. Thus, even when the rotational speed of the rotor 18 increases, reverse flow of air from the non-output-side end plate coolant passage 26 to the radial-direction passage 71 can be inhibited and it is possible to continue pumping up the coolant 5. Since reverse flow of air to the radial-direction passage 71 is inhibited, it becomes possible to increase the rotational speed of the rotor 18, and owing to increase in the rotational speed of the rotor 18, the rotational speed of the impeller 30 also increases, whereby the coolant 5 can be efficiently pumped up and the stator 12 and the rotor 18 can be efficiently cooled. As a result, it is possible to obtain the rotating electric machine 1 in which the coolant 5 can be efficiently circulated, thus having improved cooling performance. Further, since the coolant can be efficiently circulated even when the rotation speed is increased, the rotating electric machine 1 can be operated with high efficiency.

As described above, in embodiment 3, a structure for causing loss of pressure (narrowed portion 92, bent portion 93) is further provided to the radial-direction passage 71 in the rotating electric machine 1 of embodiment 1. Therefore, even when the rotational speed of the rotor 18 increases, reverse flow of air to the radial-direction passage 71 can be inhibited. As a result, it is possible to obtain the rotating electric machine 201 in which the coolant can be efficiently pumped up and circulated, thus having improved cooling performance.

### Embodiment 4

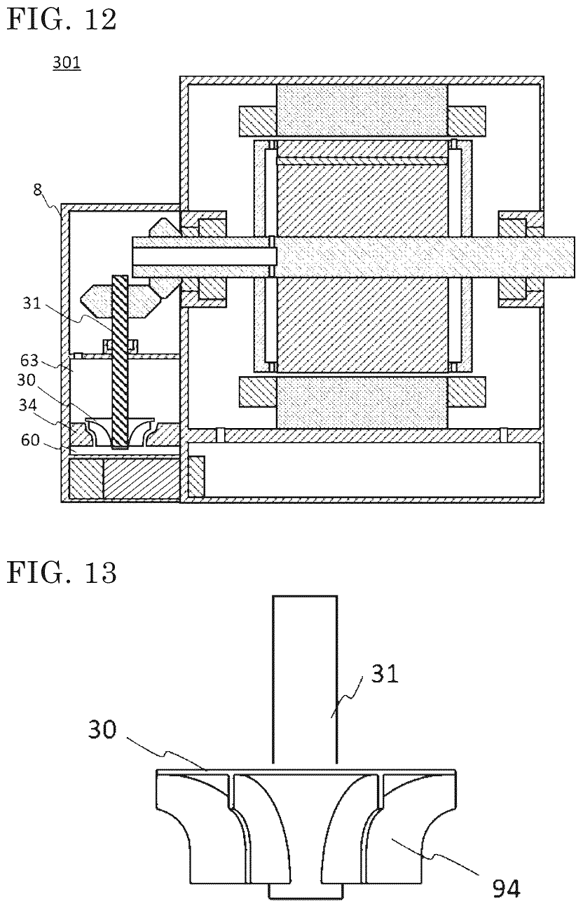

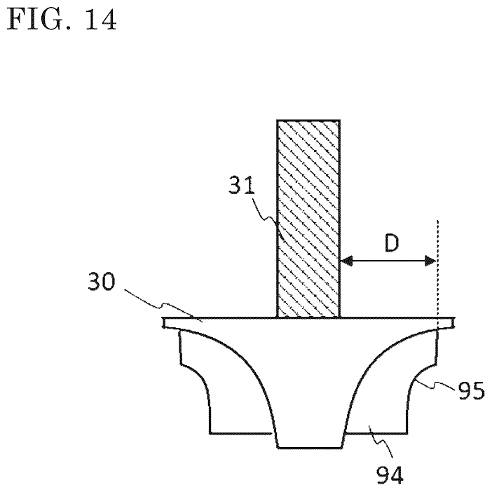

A rotating electric machine 301 according to embodiment 4 of the present disclosure will be described with reference to FIG. 12, FIG. 13, and FIG. 14. In FIG. 12, FIG. 13, and FIG. 14, the same reference characters as those in FIG. 1 denote the same or corresponding parts. The rotating electric machine 301 according to embodiment 4 is obtained by changing the shapes of the impeller 30 and the impeller cover 34 in the rotating electric machine 1 according to embodiment 1. Description of the same configurations and operations as those in embodiment 1 is omitted.

FIG. 12 is a sectional view of the rotating electric machine 301 according to embodiment 4 of the present disclosure. FIG. 13 is a schematic view showing the impeller 30 according to embodiment 4 of the present disclosure. FIG. 14 is a sectional view of the impeller 30 shown in FIG. 13, taken along a plane in parallel to the longitudinal direction of the second shaft 31.

As shown in FIG. 12, the impeller 30 is provided at the lower end of the second shaft 31. The second shaft 31 penetrates the center part of the impeller 30 and is fixed to the second shaft 31 so as to rotate together with the second shaft 31.

As shown in FIG. 13, the impeller 30 has vanes 94 arranged with intervals from each other along the circumferential direction of the second shaft 31 and having surfaces perpendicular to the rotation direction of the impeller 30. Since the vanes 94 have surfaces perpendicular to the rotation direction of the impeller 30, it becomes possible to pump up the coolant irrespective of the rotation direction of the rotor 18.

Here, as shown in FIG. 14, a radial-direction distance from the second shaft 31 to an outer peripheral edge 95 of the vane 94 is defined as a radial-direction distance D. Each vane 94 in the present embodiment 4 is formed such that the radial-direction distance D from the second shaft 31 to the outer peripheral edge of the vane 94 reduces toward the lower end of the second shaft 31. That is, the vanes 94 have such a shape that tapers from the second coolant storage portion 63 toward the first coolant storage portion 60.

In FIG. 12 again, the impeller cover 34 in embodiment 4 has a shape along a track of the outer peripheral edges 95 of the vanes 94 when the impeller 30 rotates. The shape along the track of the outer peripheral edges 95 refers to a mortar-like shape that is along the ridges of the outer peripheral edges 95 of the vanes 94 and is spaced from the impeller 30 by a certain interval, as shown in FIG. 12, for example. The lower ends of the vanes 94 are immersed in the coolant 5 stored in the first coolant storage portion 60, and due to a centrifugal force caused by rotation of the impeller 30, a pressure difference arises in the impeller 30, thus enabling the coolant to be pumped up. Since the impeller cover 34 has a shape along the shapes of the vanes 94, a pressure generated by rotation of the impeller 30 can be maximally increased. Thus, by forming the impeller cover 34 in a shape along the track of the outer peripheral edges 95 of the vanes 94, the pressure difference in the impeller 30 can be maximized. As a result, the coolant 5 stored in the first coolant storage portion 60 can be sucked and caused to flow radially outward of the vanes of the impeller 30, more efficiently than in the rotating electric machine 1 in embodiment 1.

In the rotating electric machine 301 according to the present embodiment 4, the impeller 30 has the vanes 94 arranged with intervals from each other along the circumferential direction of the second shaft 31 and having surfaces perpendicular to the rotation direction of the impeller 30. Each vane 94 is formed such that the radial-direction distance D from the second shaft 31 to the outer peripheral edge 95 of the vane 94 reduces toward the lower end of the second shaft 31. Further, the impeller cover 34 is formed in a shape along the track of the outer peripheral edges 95 of the vanes 94 when the impeller 30 rotates. With this structure, the coolant 5 can be efficiently pumped up and the stator 12 and the rotor 18 can be efficiently cooled. Thus, the rotating electric machine 301 having improved cooling performance can be obtained. In addition, even when the rotational speed is increased, the coolant can be efficiently circulated, and therefore the rotating electric machine 301 can be operated with high efficiency.

As described above, in embodiment 4, the shapes of the impeller 30 and the impeller cover 34 are changed as compared to those in the rotating electric machine 1 according to embodiment 1, whereby, in addition to the same effects as in embodiment 1, it becomes possible to obtain the rotating electric machine 301 in which the coolant 5 can be pumped up and circuited irrespective of the rotation direction of the rotor 18, thus having improved cooling performance. In addition, the impeller cover 34 is formed in a shape along the track of the outer peripheral edges 95 of the vanes 94, whereby the pressure difference in the impeller 30 can be maximized. Therefore, it becomes possible to obtain the rotating electric machine 301 in which the coolant 5 can be pumped up and circulated more efficiently than in embodiment 1, thus having improved cooling performance.

The above embodiments may be combined, modified, or simplified as appropriate within the scope of technical ideas described in the embodiments.

### DESCRIPTION OF THE REFERENCE CHARACTERS

1, 101, 201, 301 rotating electric machine
2 housing
3 output-side bracket
4 non-output-side bracket
5 coolant
6 external coolant
7 drain portion
8 casing
9 passage hole
10 stator core
11 coil
12 stator
13 rotor core
14 permanent magnet
15 output-side end plate
16 non-output-side end plate
17 first shaft
18 rotor
20 magnet insertion hole
21 stress relaxing hole
22 magnet cooling hole
23 output-side ejection hole
24 non-output-side ejection hole
25 output-side end plate coolant passage
26 non-output-side end plate coolant passage
27 output-side bearing mechanism
28 non-output-side bearing mechanism
29 oil seal
30 impeller
31 second shaft
32 motive-power transmission mechanism
33 bevel gear
33a first gear
33b second gear
34 impeller cover
40 heat exchanger
41 plate-type heat exchanger
42 coolant flow-in/out hole
43 coolant flow-in/out hole
44 external coolant flow-in/out hole
45 external coolant flow-in/out hole
46 heat transfer plate
47 first flow-in/out direction switching mechanism
48 second flow-in/out direction switching mechanism
49 coolant passage
50 external coolant passage
60 first coolant storage portion
61 impeller bearing mechanism
62 support member
63 second coolant storage portion
64 third coolant storage portion
65 communication hole
70 axial-direction passage
71 radial-direction passage
90 heat dissipation fin
91 reverse-flow preventing member
91a distal end
92 narrowed portion
93 bent portion
94 vane
95 outer peripheral edge

1.-13. (canceled)

14. A rotating electric machine comprising:
a housing;
a stator housed in the housing;
a rotor which rotates on an inner side of the stator;
a first shaft which extends in a rotation axis direction of the rotor so as to penetrate the rotor, and rotates together with the rotor;
a second shaft extending in an up-down direction crossing an axial-length direction of the first shaft;
a motive-power transmission mechanism which transmits rotational motive power of the first shaft to the second shaft;
an impeller which is provided at a lower end of the second shaft and pumps up, to at least a height of the first shaft, a coolant present at a lower position than the first shaft in the housing, through rotation of the second shaft;
a passage for supplying the coolant pumped up to the height of the first shaft, to heat-generation parts of the rotor and the stator; and
a casing which is provided at a side surface portion of the housing and houses one end of the first shaft that protrudes from the housing, the second shaft, the motive-power transmission mechanism, and the impeller, wherein
the impeller pushes up the coolant present at the lower position than the first shaft to at least the height of the first shaft with the coolant moving along an inner wall of the casing, thus pumping up the coolant.

15. The rotating electric machine according to claim 14, further comprising:
a drain portion which is provided at a bottom of the housing and stores the coolant;
a heat exchanger for cooling the coolant; and
a first coolant storage portion which is provided on a lower end side of the second shaft in the casing and stores the coolant cooled by the heat exchanger.

16. The rotating electric machine according to claim 15, wherein
the heat exchanger is provided at a bottom of the casing so as to be in contact with the side surface portion of the housing.

17. The rotating electric machine according to claim 16, wherein
the motive-power transmission mechanism has a first gear provided at the one end of the first shaft, and a second gear provided at one end of the second shaft and meshed with the first gear.

18. The rotating electric machine according to claim 15, further comprising:
a second coolant storage portion which is provided above the first coolant storage portion and in which the coolant is to rise along the second shaft; and
an impeller cover provided between the first coolant storage portion and the second coolant storage portion, and having a port for the impeller to suck the coolant.

19. The rotating electric machine according to claim 18, wherein
the casing has a support member partitioning a space above the first coolant storage portion into the second coolant storage portion and a third coolant storage portion, the support member having a communication hole through which the second coolant storage portion and the third coolant storage portion communicate with each other, and
in the third coolant storage portion, a reverse-flow preventing member is provided for preventing reverse flow of the coolant when rotation of the rotor is stopped.

20. The rotating electric machine according to claim 15, wherein
the first shaft has an axial-direction passage provided along the rotation axis direction in the first shaft, and a radial-direction passage communicating with the axial-direction passage and penetrating in a radial direction of the first shaft.

21. The rotating electric machine according to claim 20, wherein
the radial-direction passage has such a shape that a passage sectional area on a radially outer side is smaller than a passage sectional area on a radially inner side.

22. The rotating electric machine according to claim 20, wherein
an end of the radial-direction passage is bent in a direction opposite to a rotation direction of the rotating electric machine.

23. The rotating electric machine according to claim 15, further comprising a heat dissipation fin attached to an outer surface of the housing.

24. The rotating electric machine according to claim 15, wherein
the heat exchanger has a coolant passage serving as a passage for the coolant, and an external coolant passage serving as a passage for an external coolant flowing in from outside of the casing, and allows the coolant and the external coolant to exchange heat therebetween.

25. The rotating electric machine according to claim 14, wherein
the impeller has a disk and a plurality of vanes provided at a lower surface of the disk.

26. A rotating electric machine comprising:
a housing;
a stator housed in the housing;
a rotor which rotates on an inner side of the stator;
a first shaft which extends in a rotation axis direction of the rotor so as to penetrate the rotor, and rotates together with the rotor;
a second shaft extending in an up-down direction crossing an axial-length direction of the first shaft;
a motive-power transmission mechanism which transmits rotational motive power of the first shaft to the second shaft;
an impeller which is provided at a lower end of the second shaft and pumps up, to at least a height of the first shaft, a coolant present at a lower position than the first shaft in the housing, through rotation of the second shaft;
a passage for supplying the coolant pumped up to the height of the first shaft, to heat-generation parts of the rotor and the stator;
a casing which is provided at a side surface portion of the housing and houses one end of the first shaft that protrudes from the housing, the second shaft, the motive-power transmission mechanism, and the impeller;
a drain portion which is provided at a bottom of the housing and stores the coolant;
a heat exchanger for cooling the coolant; and
a first coolant storage portion which is provided on a lower end side of the second shaft in the casing and stores the coolant cooled by the heat exchanger;
a second coolant storage portion which is provided above the first coolant storage portion and in which the coolant is to rise along the second shaft;
an impeller cover provided between the first coolant storage portion and the second coolant storage portion, and having a port for the impeller to suck the coolant;
wherein
the impeller has a disk and a plurality of vanes provided at a lower surface of the disk, and
the impeller pushes up the coolant present at the lower position than the first shaft to at least the height of the first shaft with the coolant moving along an inner wall of the casing, thus pumping up the coolant, and
wherein
the impeller cover is provided so as to extend from an inner side surface of the casing toward the impeller, and an upper end of the impeller cover is located lower than the disk of the impeller.

27. The rotating electric machine according to claim 25, wherein
the vanes are arranged with intervals from each other along a circumferential direction of the second shaft and have surfaces perpendicular to a rotation direction of the impeller, and
each of the vanes is formed such that a radial-direction distance from the second shaft to an outer peripheral edge of the vane reduces toward the lower end of the second shaft.

28. A rotating electric machine comprising:
a housing;
a stator housed in the housing;
a rotor which rotates on an inner side of the stator;
a first shaft which extends in a rotation axis direction of the rotor so as to penetrate the rotor, and rotates together with the rotor;
a second shaft extending in an up-down direction crossing an axial-length direction of the first shaft;
a motive-power transmission mechanism which transmits rotational motive power of the first shaft to the second shaft;
an impeller which is provided at a lower end of the second shaft and pumps up, to at least a height of the first shaft, a coolant present at a lower position than the first shaft in the housing, through rotation of the second shaft;
a passage for supplying the coolant pumped up to the height of the first shaft, to heat-generation parts of the rotor and the stator;
a casing which is provided at a side surface portion of the housing and houses one end of the first shaft that protrudes from the housing, the second shaft, the motive-power transmission mechanism, and the impeller;
a drain portion which is provided at a bottom of the housing and stores the coolant;
a heat exchanger for cooling the coolant;
a first coolant storage portion which is provided on a lower end side of the second shaft in the casing and stores the coolant cooled by the heat exchanger;
a second coolant storage portion which is provided above the first coolant storage portion and in which the coolant is to rise along the second shaft;
an impeller cover provided between the first coolant storage portion and the second coolant storage portion, and having a port for the impeller to suck the coolant;
wherein
the impeller has a disk and a plurality of vanes provided at a lower surface of the disk, and
the impeller pushes up the coolant present at the lower position than the first shaft to at least the height of the first shaft with the coolant moving along an inner wall of the casing, thus pumping up the coolant,
wherein
the vanes are arranged with intervals from each other along a circumferential direction of the second shaft and have surfaces perpendicular to a rotation direction of the impeller, and
each of the vanes is formed such that a radial-direction distance from the second shaft to an outer peripheral edge of the vane reduces toward the lower end of the second shaft, and
wherein
the impeller cover has a shape along a track of the outer peripheral edges of the vanes when the impeller rotates.
